(19) United States
(12) Patent Application Publication
(10) Pub. No.: US 2024/0249461 A1
(43) Pub. Date: Jul. 25, 2024

(54) VECTOR GRAPHIC TEXTURE ENGINE

(71) Applicant: Meta Platforms Technologies, LLC, Menlo Park, CA (US)

(72) Inventors: Sushant Kondguli, Newark, CA (US); Abhinav Golas, Burlingame, CA (US)

(21) Appl. No.: 18/524,631

(22) Filed: Nov. 30, 2023

Related U.S. Application Data
(60) Provisional application No. 63/480,953, filed on Jan. 20, 2023.

(51) Int. Cl. G06T 15/04; G06T 1/20; G06T 7/50; G06T 7/90; G06T 15/06; G06V 10/25

(52) U.S. Cl. CPC G06T 15/04; G06T 1/20; G06T 7/50; G06T 7/90; G06T 15/06; G06V 10/25; G06T 2207/10024

(57) ABSTRACT

In one embodiment, a computing system may determine a pixel position in a display coordinate system, the pixel position being associated with a pixel. The system may project the pixel position into an object-space coordinate system to determine a projected pixel position associated with vector shapes each being associated with a texture color. The vector shapes may be associated with a texture coordinate system. The system may determine a bounding box in the texture coordinate system based on the projected pixel position in the texture coordinate system and corner positions associated with the pixel. The system may identify one or more first vector shapes that are associated with the bounding box of the pixel based on relative positions of the one or more first vector shapes and the bounding box in the texture coordinate system.

### PRIORITY

This application claims the benefit under 35 U.S.C. § 119(c) of U.S. Provisional Patent Application No. 63/480,953, filed 20 Jan. 2023, which is incorporated herein by reference.

### TECHNICAL FIELD

This disclosure generally relates to computer vision technology, in particular to content rendering for artificial reality systems.

### BACKGROUND

Computer-generated graphics may include texts, numbers, symbols, or other types of glyphs. The glyphs may be rendered in a three-dimensional (3D) space, such as in virtual reality or augmented reality. As an example, a computer-generated 3D scene may include a document placed on a table, a poster on a wall, a can with a logo, etc. The document, poster, and logo may each contain glyphs. Conventionally, glyphs in 3D scenes are treated and processed like images. For example, a text phrase that is to appear in a 3D scene (e.g., a poster on a wall) would be stored as a texture image with color information at a particular resolution. At rendering time, the rendering engine would sample the texture image to integrate color information associated with the text phrase into the 3D scene. Since the text phrase may need to be rendered on any 3D surface and with any resolution, orientation, and distortion, the resulting display of the text phrase may have undesirable artifacts, such as blurring, aliasing, and other inaccuracies.

### SUMMARY OF PARTICULAR EMBODIMENTS

Particular embodiments of this disclosure relate to systems and methods of using a pixel bounding box in the texture space to filter out a large number of vector shapes that fail to intersect with the projected pixel area. Instead of using a separate, custom chip for handling vector graphics texture sampling, the system may integrate the vector graphic rendering capability into in the GPUs at the hardware level (by integrating a vector texture engine into GPU) to improve the rendering speed and performance efficiency. The GPU may support both vector graphics and conventional bitmap sampling. The GPU, at the shader phase, may selectively choose to perform bitmap sampling or vector graphics sampling (e.g., for rendering high quality text attached to other objects). When the GPU operates under the vector graphic sampling mode, particular embodiments of this disclosure may provide an optimization step to efficiently filter out shapes that do not overlapping with a pixel area. For example, the GPU may first determine a pixel position for a pixel in a display coordinate system. Then, the system may project the pixel position into a 3D coordinate system to determine a projected pixel position in the 3D coordinate system. The projected pixel position may be determined by casting a ray from a viewpoint of the user passing through the pixel position to a surface of a mesh grid model of a virtual object in the 3D coordinate system. The projected position may correspond to an intersecting point of the casted ray with the surface of the mesh grid model of the virtual object model.

The surface of the mesh grid model may be mapped to a texture coordinate system associated with a texture space including a number of vector shapes (e.g., lines, triangles, trapezoids, etc.) with each vector shapes being associated with a texture color. The system may determine the four corners of the pixel and determine a bounding box for the projected pixel area in the texture coordinate system. The bounding box may be aligned to the two dimensions of the texture coordinate system. In other words, each edge of the bounding box may be parallel to one dimension of the texture coordinate system. Such aligned bounding box may allow the later comparison with the vector shapes to be more efficient because the vector shapes are in the texture coordinate system. The system may check each vector shapes (e.g., trapezoids) against the bounding box to filter out the vector shapes that cannot possibly intersect the projected pixel area. This may drastically reduce the number of vector shapes (e.g., primitives) that need to be transformed and processed for determining the pixel color value.

After that, the system may transform the remaining vector shapes that may intersect with the projected pixel area into the display coordinate system, and determine for each of these vector shapes, whether it intersect with the pixel area in the display coordinate system. For the vector shape that does intersect with the pixel area, the system may compute a coverage proportion or fraction value for the pixel area that overlap with the vector shape. The coverage proportion may be percentage value of the pixel area that is overlapped by the vector shape divided by the pixel area. After that, the system may determine, for the current pixel, a pixel color value based on the texture colors of the intersecting vector shapes and the corresponding coverage proportion values. For example, if 35% of the pixel is covered by a vector shape associated with a red color, then the color of the pixel should be 35% the red value. If there are multiple vector shapes intersect with the pixel area, the system may determine the pixel color based on the respective coverage proportion and the associated color values of all these vector shapes that intersect with the pixel area.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example virtual reality system.

FIG. 1B illustrates an example augmented reality system.

FIG. 1C illustrates an example content rendering pipeline used in GPUs of AR/VR systems.

FIG. 2 illustrates conceptual relationships between a virtual camera, a virtual display screen, and virtual 3D objects in a 3D space.

FIG. 3A illustrate an example process of projecting a pixel position to a texture coordinate.

FIG. 3B illustrates an example process of determining a bounding box.

FIG. 3C illustrates example vector shapes that intersect with the bounding box of the pixel.

FIG. 4 illustrates an example process of computing the coverage proportion of the pixel area by an intersecting vector shape.

FIG. 5 illustrates an example hardware implementation using the vector texture engine.

FIG. 6 illustrates example inner blocks of the vector texture engine (VTE).

FIG. 7 illustrates an example method of using a bounding box to identify vector shapes to be used to determine a color value for the pixel.

FIG. 8 illustrates an example computer system.

### DESCRIPTION OF EXAMPLE EMBODIMENTS

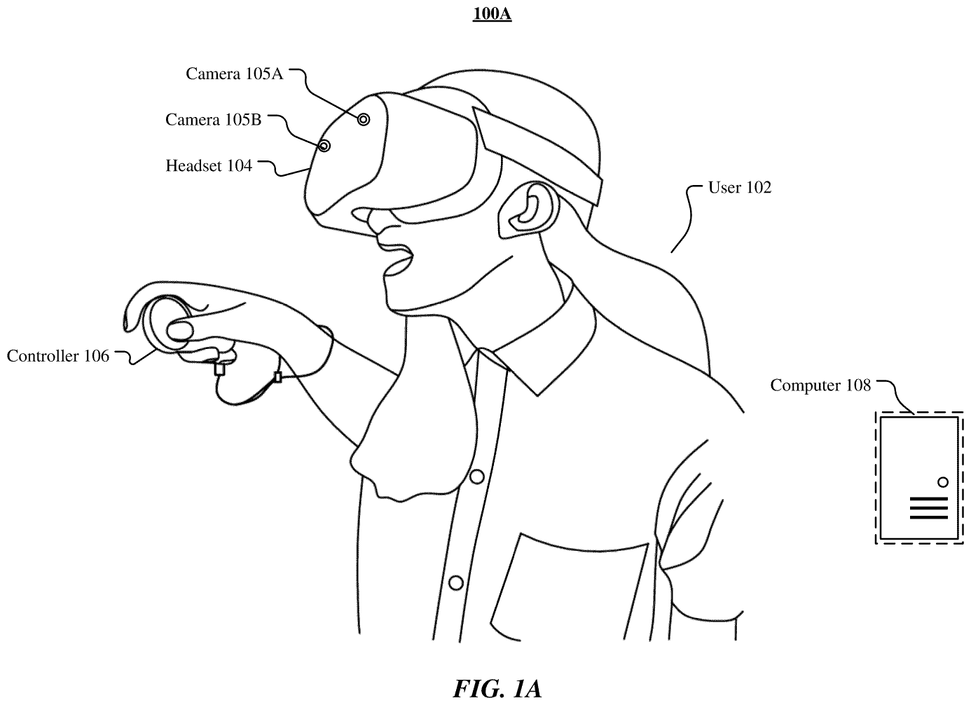

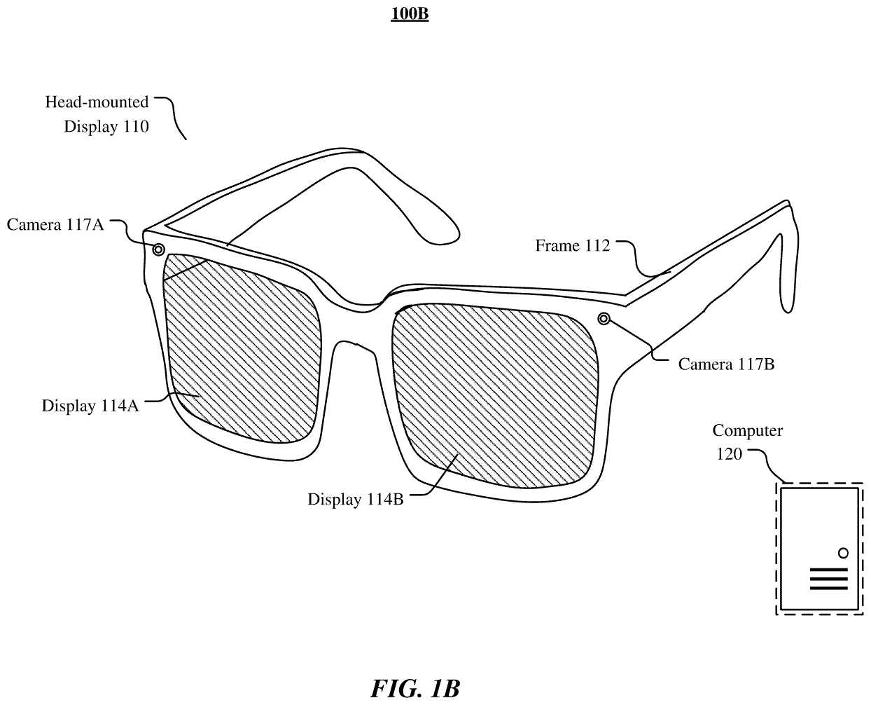

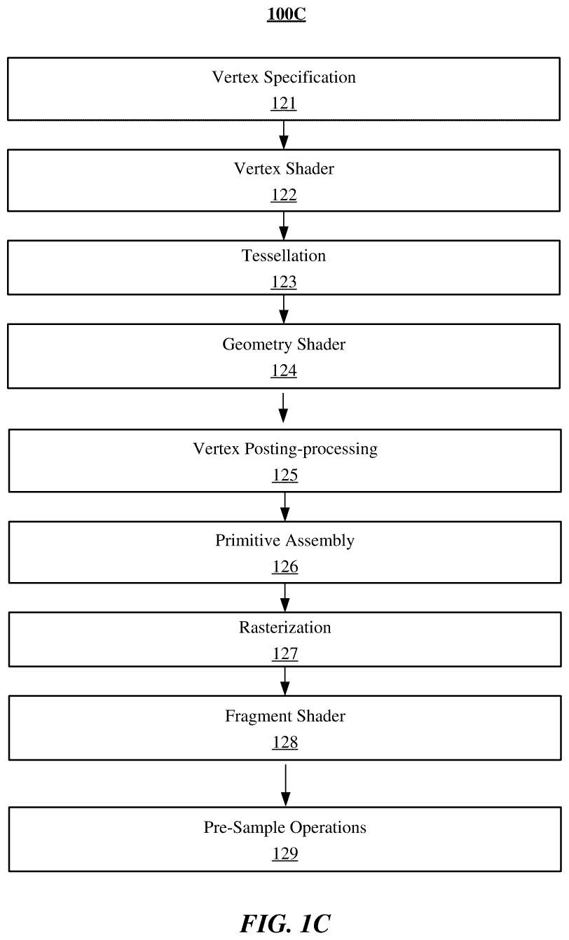

FIG. 1A illustrates an example artificial reality system 100A with a controller 106. In particular embodiments, the artificial reality system 100A may be a virtual reality system, an augmented reality system, or a mixed reality system. The artificial reality system 100A may include a head-mounted headset 104, a controller 106, and a computing system 108. A user 102 may wear the head-mounted headset 104, which may display visual artificial reality content to the user 102. The headset 104 may include an audio device that may provide audio artificial reality content to the user 102. In particular embodiments, the headset 104 may include one or more cameras which can capture images and videos of environments. For example, the headset 104 may include front-facing cameras 105A and 105B to capture images in the environment of the user 102 and may include one or more cameras facing other direction (not shown) to capture the images of the user's body or the environment from other perspective. The headset 104 may include an eye tracking system to determine the vergence distance of the user 102. The headset 104 may be referred as a head-mounted display (HMD). The controller 106 may include a trackpad and one or more buttons. The controller 106 may receive inputs from the user 102 and relay the inputs to the computing system 108. The controller 106 may also provide haptic feedback to the user 102. The computing system 108 may be connected to the headset 104 and the controller 106 through cables or wireless communication connections. The computing system 108 may control the headset 104 and the controller 106 to provide the artificial reality content to the user 102 and may receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., AR glasses) comprising a frame 112, one or more displays 114A and 114B, and a computing system 120, etc. The displays may be transparent or translucent allowing a user wearing the HMD 110 to look through the displays 114A and 114B to see the real world, and at the same time, may display visual artificial reality content to the user. The HMD 110 may include an audio device that may provide audio artificial reality content to users. In particular embodiments, the HMD 110 may include one or more cameras (e.g., 117A and 117B), which can capture images and videos of the surrounding environments. The HMD 110 may include an eye tracking system to track the vergence movement of the user wearing the HMD 110. The augmented reality system 100B may further include a controller (not shown) having a trackpad and one or more buttons. The controller may receive inputs from the user and relay the inputs to the computing system 120. The controller may provide haptic feedback to the user. The computing system 120 may be connected to the HMD 110 and the controller through cables or wireless connections. The computing system 120 may control the HMD 110 and the controller to provide the augmented reality content to the user and receive inputs from the user. The computing system 120 may be a standalone host computer system, an on-board computer system integrated with the HMD 110, a mobile device, or any other hardware platform capable of providing artificial reality content to and receiving inputs from users.

FIG. 1C illustrates an example content rendering pipeline 100C used in GPUs of AR/VR systems. As an example and not by way of limitation, the content rendering pipeline 100C used in GPUs of AR/VR systems may include a number of functional modules for vertex processing, vertex post-processing, scan conversion and primitive parameter interpolation, fragment shading, and pre-sampling processing, etc. The process of vertex specification 121 may be where the application sets up an ordered list of vertices to send to the content rendering pipeline. These vertices may define the boundaries of a primitive which are basic drawing shapes, like triangles, lines, and points. The vertices may be interpreted as primitives via a later stage. This part of the pipeline may deal with objects like vertex array and vertex buffer. A vertex's data may be a series of attributes each attribute being a small set of data that the next stage will do computations on. While a set of attributes specify a vertex, a vertex's attribute does not need to be a position or normal. Attribute data may be arbitrary; the meaning assigned to any of it may happen in the vertex processing stage. Vertices fetched due to the prior vertex rendering stage begin their processing. The vertex processing stages may be programmable operations. This allows user code to customize the way vertices are processed. Each stage represents a different kind of shader operation.

Once the vertex data is specified, the vertex data may be rendered as primitives. The vertex shader 122 perform basic processing of each individual vertex. Vertex shaders may receive the attribute inputs from the vertex rendering and convert the incoming vertex into a single outgoing vertex based on an arbitrary, user-defined program. The tessellation 123 may tesselate the primitives using two shader stages and fixed-function tessellators between them. The geometry shader 124 may be user-defined programs that process each incoming primitive, returning zero or more output primitives. The output of the geometry shader 124 may be zero or more simple primitives, much like the output of primitive assembly. The geometry shader 124 may remove primitives, or tessellate them by outputting many primitives for a single input. The geometry shader 124 may also tinker with the vertex values, either doing some of the work for the vertex shader or just to interpolate the values when tessellating them.

The vertex post-processing 125 may write the output of the geometry shader 124 or primitive assembly to a series of buffer objects that have been setup for this purpose, under the transform feedback mode, allowing the user to transform data via vertex and geometry shaders, then hold on to that data for use later. The primitive assembly 126 may be the process of collecting a run of vertex data output from the prior stages and composing it into a sequence of primitives. The type of primitive the user rendered with determine how this process works. The output may be an ordered sequence of simple primitives (lines, points, or triangles). The rasterization 127 may rasterize the primitives and output a sequence of fragments. The fragment shader 128 may process the data for each fragment from the rasterization stage. The output from the fragment shader 128 may be a list of colors of the color buffers being written to, a depth value, and a stencil value. The fragment shader 128 may control the color values and depth values. The pre-sample operations 129 may include a sequence of steps including, for example, culling tests, pixel ownership tests, scissor test, stencil test, depth test, etc. The fragment data may be written to the framebuffer after color blending to be used in the later display process.

To minimize aliasing artifacts when rendering certain graphics such as those containing text, AR/VR systems may use vector graphics (analytical definitions) rather than using bitmaps when sampling from textures to determine the color value of pixels. Traditional AR/VR systems may use a separate and dedicated chip for handling such vector graphics. However, such solutions may have disadvantages. For example, the separate chip may require additional space on the circuit board which is very limited for AR/VR systems. Also, as a separate chip, the data needs to be transformed between the vector graphic chip and other sub-modules, which consume more system bandwidth and energy and need programmers to specifically program these chips to work properly. Furthermore, during the vector graphic rendering process, the system may need to transform a large number of vector shapes between different coordinate system to determine the color values for the pixels. For example, as part of vector graphics sampling, the GPU may need to calculate the percentage of each pixel that overlaps with a primitive shape (e.g., a trapezoid, a curve segment, a triangle, etc.). Doing so could be overly costly when there are millions of such primitive shapes because each one would have to be transformed between different coordinates, which require matrix multiplications. Such transformation may consume a large amount of computational resource and make the process inefficient.

To solve these problems, particular embodiments of this disclosure relate to systems and methods of using a pixel bounding box in the texture space to filter out a large number of vector shapes that fail to intersect with the projected pixel area. Instead of using a separate, custom chip for handling vector graphics texture sampling, the system may integrate the vector graphic rendering capability into in the GPUs at the hardware level (by integrating a vector texture engine into GPU) to improve the rendering speed and performance efficiency. The GPU may support both vector graphics and conventional bitmap sampling. By integrating the vector texture engine into GPU, the GPU may allow programmers to access bitmap and vector textures in the same shader when shading a scene, improving the programmability of the GPU for rendering display contents. The GPU, at the shader phase, may selectively choose to perform bitmap sampling or vector graphics sampling (e.g., for rendering high quality text attached to other objects). When the GPU operates under the vector graphic sampling mode, particular embodiments of this disclosure may provide an optimization step to efficiently filter out shapes that do not overlapping with a pixel area. For example, the GPU may first determine a pixel position for a pixel in a display coordinate system. Then, the system may project the pixel position into a 3D coordinate system to determine a projected pixel position in the 3D coordinate system. The projected pixel position may be determined by casting a ray from a viewpoint of the user passing through the pixel position to a surface of a mesh grid model of a virtual object in the 3D coordinate system. The projected position may correspond to an intersecting point of the casted ray with the surface of the mesh grid model of the virtual object model.

The surface of the mesh grid model may be mapped to a texture coordinate system associated with a texture space including a number of vector shapes (e.g., lines, triangles, trapezoids, etc.) with each vector shapes being associated with a texture color. The system may determine the four corners of the pixel and determine a bounding box for the projected pixel area in the texture coordinate system. The bounding box may be aligned to the two dimensions of the texture coordinate system. In other words, each edge of the bounding box may be parallel to one dimension of the texture coordinate system. Such aligned bounding box may allow the later comparison with the vector shapes to be more efficient because the vector shapes are in the texture coordinate system. The system may check each vector shapes (e.g., trapezoids) against the bounding box to filter out the vector shapes that cannot possibly intersect the projected pixel area. This may drastically reduce the number of vector shapes (e.g., primitives) that need to be transformed and processed for determining the pixel color value.

After that, the system may transform the remaining vector shapes that may intersect with the projected pixel area into the display coordinate system, and determine for each of these vector shapes, whether it intersect with the pixel area in the display coordinate system. For the vector shape that does intersect with the pixel area, the system may compute a coverage proportion or fraction value for the pixel area that overlap with the vector shape. The coverage proportion may be percentage value of the pixel area that is overlapped by the vector shape divided by the pixel area. After that, the system may determine, for the current pixel, a pixel color value based on the texture colors of the intersecting vector shapes and the corresponding coverage proportion values. For example, if 35% of the pixel is covered by a vector shape associated with a red color, then the color of the pixel should be 35% the red value. If there are multiple vector shapes intersect with the pixel area, the system may determine the pixel color based on the respective coverage proportion and the associated color values of all these vector shapes that intersect with the pixel area.

By using the bounding box to filter out the vector shapes that have no chance to overlap with the pixel area, the system may drastically reduce the number of vector shapes that need to be transformed into the display coordinate and significantly improve the speed for rendering high quality test attached to virtual object in the AR/VR system. By allowing the GPU to select from the bitmap texture and vector graphic based texture, the GPU may have the flexibility to handle both bitmap-based texture and the vector graphic based texture in a power efficient way.

In a typical computer-graphics rendering pipeline, after solving the visibility problem of determining which primitives (e.g., polygons used for modeling a virtual object) are visible, a rendering engine may then be tasked with determining what colors to display on a display screen. For each pixel on the user's display screen, the rendering engine may determine what color it should present. The particular color presented may depend on several factors, including the viewpoint of the user (commonly represented by or referred to as a virtual camera), the virtual object that is visible from the user's viewpoint through the pixel, lighting, etc.

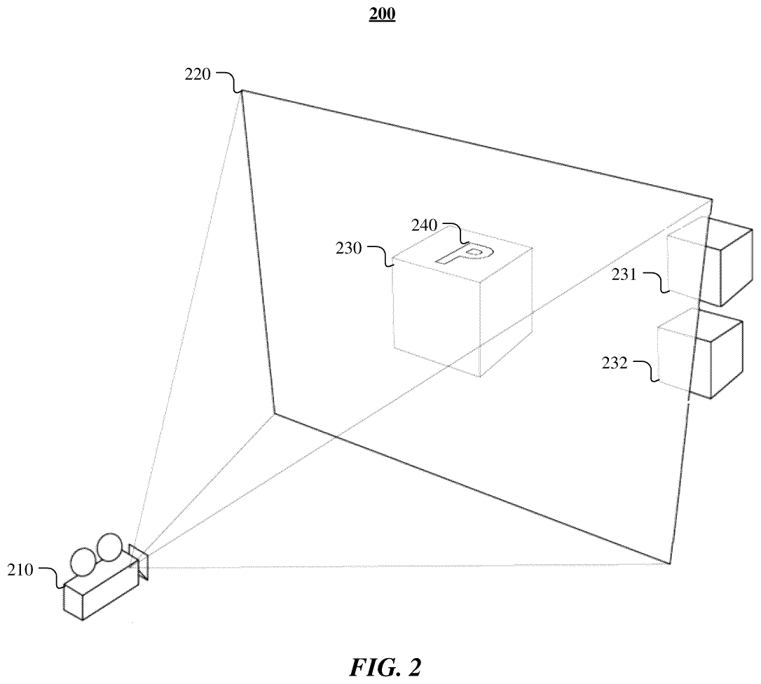

FIG. 2 illustrates conceptual relationships between a virtual camera 210, a virtual display screen 220, and virtual 3D objects 230-232 in a 3D space 200. The 3D space 200 may be a 3D model of an environment and may include any virtual object, such as cars, people, animals, buildings, vegetation, etc. The virtual object may be defined using primitive shapes associated with a mesh grid model of the virtual object. The primitive shapes may include, for example, but not limited to, triangles, polygons, spheres, cones, iso-surfaces, or any mathematical surface. When the primitive shapes are presented by vector, they may be referred to as “vector shapes.” The 3D model for an object may specify how primitives are interconnected to define the contours of the object. In addition, a 3D object may have a variety of parameters that influence how it appears, including translucency properties, reflective properties colors, and surface textures. For simplicity, FIG. 1 illustrates three objects, namely cubes 230, 231, 232. Cube 230, in particular, is designed to display a glyph 240 (which is a high quality text of letter “P”) on one of its sides. Although the example in FIG. 1 only illustrates cubes 230-232, one of ordinary skill in the art would recognize that the 3D space 200 may include any type of objects with any glyphs appear in any manner. As an example, a 3D environment may include a 3D table with a document on top that contains glyphs, such as text.

Although the 3D space 200 is defined in 3D, conventional user displays are 2D. Thus, to give a user the illusion that he is viewing a 3D scene, the rendering engine determines what colors to display on the user's 2D display using properties of the virtual 3D model. As previously mentioned, how the 3D scene should appear on the 2D display could depend on the viewpoint from which the 3D scene is observed. Conceptually, the rendering algorithm may represent the viewpoint (which may be that of a user) with a virtual camera 210. Based on the orientation and other properties of the camera 210, the rendering engine may determine a virtual display screen 220 through which the 3D space 200 is observed. The virtual display screen 220 may correspond to the display pixels of the head-mounted display (HMD) of the AR/VR system. The display screen 220, which has a 2D display coordinate system, may act as a virtual window into the 3D space, similar to the physical display of a user device (e.g., a computer monitor, television monitor, smartphone screen, etc.). Therefore, the virtual display screen 220 may be used to represent the user's physical display including corresponding pixel areas that map to the physical pixels of the physical display. Using the relative positions between each pixel area in the virtual display screen 220 and the virtual camera 210, the rendering engine may determine which portion of which object(s) in the 3D scene would be visible to the viewer through that pixel area. In particular embodiments, the rendering system may project a conceptual ray (or line of sight) from the viewpoint 210, through the particular pixel area in the virtual display screen 220, into the 3D space 200 and see what 3D objects/primitives intersect with the ray. The rendering engine may then compute the appropriate color that the pixel area should present based on properties of the portion of the 3D model that intersects with the ray.

The objects in a 3D space 200 may be defined to have particular texture. This is typically done using texture mapping. For example, a scene's designer may want a 3D scene to include a basketball. The basketball may be defined using a sphere. To make the sphere look like a basketball, the designer may indicate that a texture image should be used to determine the surface color of the sphere. The texture image, for example, may be a 2D image with the color and patterns of a typical basketball. Each segment or primitive that makes up the sphere may be mapped to a particular portion of the texture image. At rendering time, the rendering engine may determine that a ray cast through a pixel area intersects with a portion of the basketball and look up the corresponding color information from the texture image. If text should appear on the basketball as well (e.g., a logo), the text may be stored as a texture image as well and sampled during rendering.

As previously noted, storing a glyph (e.g., a character, letter, number, symbol, etc.) as a texture image has limitations, especially when the rendered scene is for virtual reality (VR) displays. Storing a glyph as a 2D texture image means that the glyph is being defined by a uniform grid of colors (e.g., an image with 100×100 resolution means it is defined by 10,000 pixels). The uniform grid of colors of the texture image of a glyph may naturally map to a 2D display screen that also has a uniform pixel grid, such as when a document is being displayed on a screen (i.e., when the respective normal vectors of the document and the display are parallel). However, when a texture image is rendered in a 3D scene, the texture image would typically undergo some form of distortion and would rarely be uniformly projected onto a display screen. For example, even if a texture is mapped onto a flat table in a 3D scene, when it is projected to the display screen (e.g., conventional flat screens, curved screens, VR headsets or optics, etc.), portions of the texture that are closer to the viewer would appear larger due to the parallax effect. In addition, the display screen and/or the surface on which the glyph is mapped may not always be uniform. For example, a VR headset's display may use curved display lenses and 3D objects in a VR scene may have any shape and size. Furthermore, since VR applications typically aim to provide users with a realistic virtual world, the VR applications may allow its users a wide degree of freedom to explore the virtual world. This means that the user may perceive virtual scenes, including the objects and glyphs within, from a wide range of viewpoints, orientations, and distances.

Consequently, a glyph, as it appears on the 2D display, may be distorted in seemingly endless manners and may need to be presented in any resolution (e.g., a user may notice, from a distance, that a document is on a table and decide to walk over to read it). Since the texture image of a glyph may not be uniformly sampled to render the distorted (but realistic) views, the glyphs may appear blurry or have other undesirable rendering artifacts (e.g., aliasing). Moreover, since glyphs such as text have fine feature details and are typically displayed over high-contrast backgrounds, any blurring, aliasing, or other types of rendering artifacts would be easily noticeable and hamper legibility. Although one way to ameliorate the problem with resolution may be to store texture images with a wide range of resolutions for every glyph, doing so is resource intensive (e.g., larger files may negatively impact system resources such as storage, memory, cache, processing, network transmission, etc.). Furthermore, using glyphs in varying resolutions would not typically solve problems related to anisotropy in the rendered footprint. For example, when rendering a glyph covered by an oval-shaped footprint, the rendering system would still have to integrate over that footprint; and when the footprint is very long and thin, problems with rendering artifacts would persist regardless of the glyph's resolution.

Particular embodiments described herein address the aforementioned problems associated with storing glyphs as texture images by using analytical definitions (e.g., vectors) to define glyphs. In particular embodiments, the GPU may select a bitmap mode or vector shape mode for texture rendering. Under the vector shape mode, the embodiments do not assume that grids are uniform and the rendered glyphs would appear much crisper, especially in the VR context. In particular embodiments, a rendering system may take as input a particular coordinate of interest (e.g., a display coordinate system corresponding to a pixel area on a virtual display screen), which may intersect with a glyph or vector shape, and determine the color that should be presented. Rather than sampling a texture image of the glyph and returning sampled color information, the rendering system, in particular embodiments, may use the analytical definition of the glyph (e.g., the vector shape) to compute a percentage or proportion of the requested pixel area that overlaps with the glyph (e.g., the vector shape). The computed coverage may then be used to determine the appropriate color for requested color area. Particular embodiments, therefore, allow a glyph or vector shape to be sampled in its native format, rather than having to wrap or stretch a texture image around an object and then approximate the answer (which leads to undesirable image artifacts, such as aliasing and blurring). Without using such approximation, the result would appear much sharper in any resolution.

For example, to render high quality text or other texture pattern on the surface of the virtual object, the color information of the texts or texture patterns may be stored as a number of vector shapes with each shape being associated with a color value. The system may use conceptual ray casting method to determine the color values for the pixels that are used to present these texts or texture patterns. The rendering system may project a conceptual ray (or line of sight) from the viewpoint 210, through a particular pixel position (e.g., a pixel center position) on the virtual display screen 220. The casted ray may intersect with a surface of a 3D model of a virtual object in the 3D space 200. That surface may be mapped to a number of vector shapes (e.g., associated with high quality text to be displayed on the surface) each being associated with a particular texture color. The color value for that particular pixel may be determined based on the color values of the vector shapes that intersect with the pixel area (e.g., the area enclosed by the four corners) of that pixel (once the vector shapes are transformed to the virtual display screen space).

Analytic pixel coverage computations may be made less compute intensive when performed in screen space. Hence, the vector shapes may be transformed into the screen space (e.g., the virtual display screen 220 as shown in FIG. 2) before the pixel coverage is computed. In this disclosure, the virtual display screen may be associated with a display coordinate system and the screen space may be referred to as a (virtual) pixel space. However, for many on-screen pixels, only a few shapes in the vector texture have non-zero coverage. So, the shapes transformation operation, which is a compute intensive operation requiring at least three multiplications per shape vertex, may be avoided if shapes with zero coverage are filtered out in advance. To quickly filter out the shapes that have zero coverage, the system may use a bounding box aligned to the texture coordinate system as a comparison reference to all the shapes in the vector texture, as discussed below.

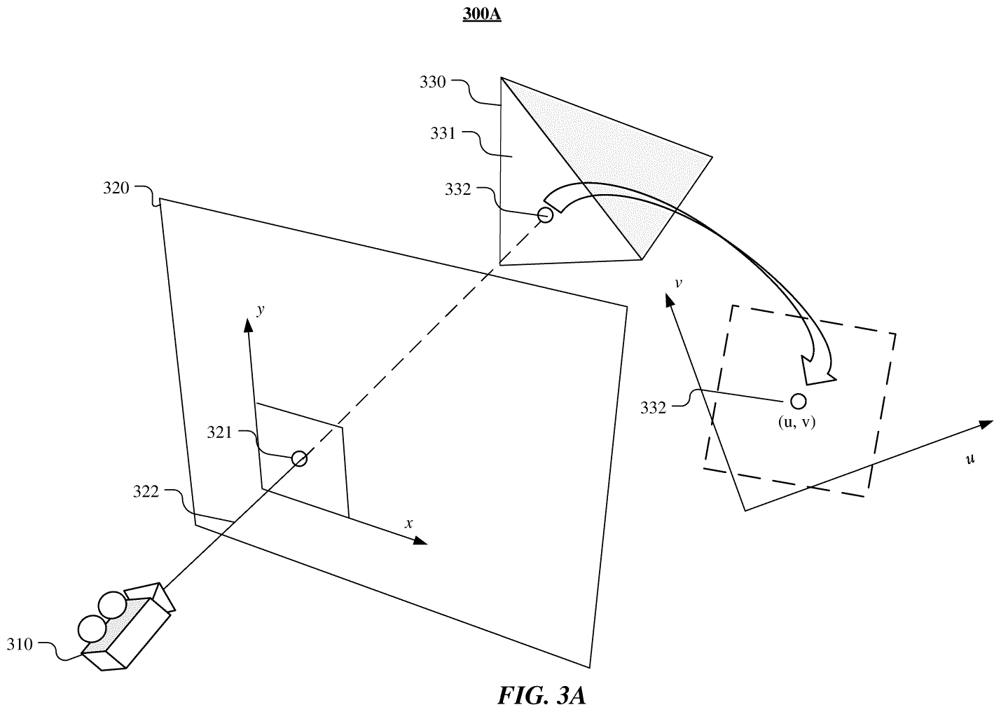

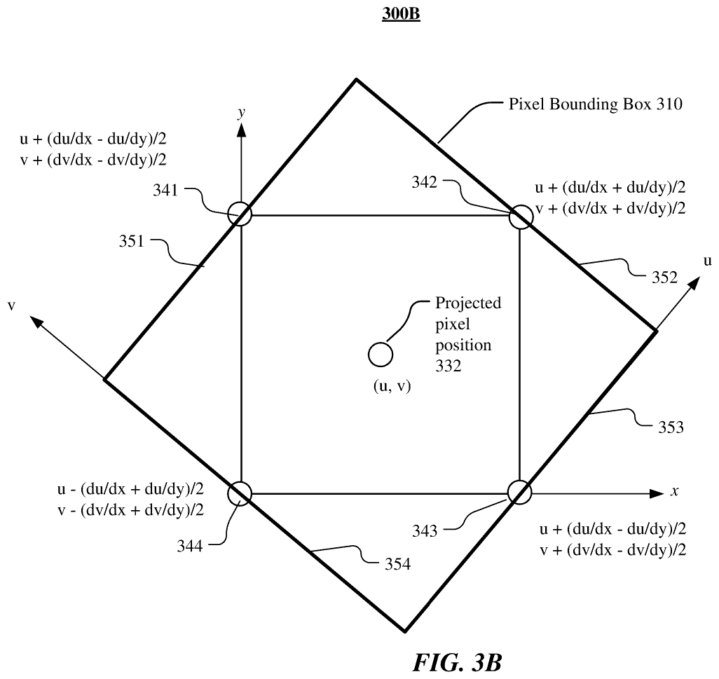

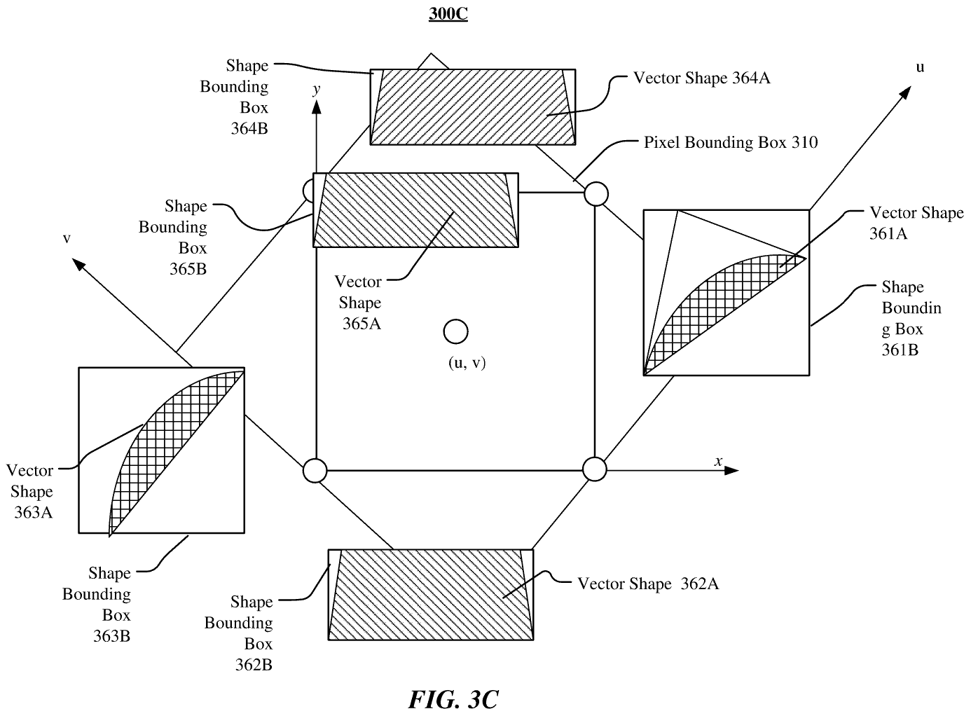

FIG. 3A illustrate an example process 300A of projecting a pixel position to a texture coordinate. As an example and not by way of limitation, the AR/VR system may need to display a high quality text or a vector graphic (e.g., in addition to or attached to a virtual object) in the virtual space. The AR/VR system may use a rendering engine to determine a color value for each pixel of the display (e.g., the head-mounted display) for displaying such high-quality text or vector graphic. The rendering engine may first determine, for a pixel of the display, a pixel position 321 in a display coordinate system, as shown by the (x, y) coordinate system in FIG. 3A. The display coordinate system may correspond to the display screen as represented by the virtual display screen as shown in FIG. 2. The pixel position 321 may be a center position of the pixel in the display coordinate system. The rendering engine may conceptually cast a ray from the viewpoint 310 of the user into the 3D virtual space, passing through the pixel position 321. The casted ray may intersect with a surface 331 of a 3D object 330 to be rendered. The intersection point 332 may be referred to as a projected pixel position in the 3D virtual space. The surface 331 may be mapped to vector textures defined in a texture coordinate system as represented by the (u, v) system in FIG. 3A. As such, the rendering engine may map the display coordinate system to the texture coordinate system by projecting the pixel position 321 to the 3D virtual space to determine the intersecting surface 331. After that, the rendering engine may determine the (u, v) coordinates of the projected pixel position 332 in the texture coordinate system to further determine the bounding box in the texture coordinate system, as shown in FIG. 3B. In particular embodiments, if two adjacent projected pixel positions on a surface area have the same color, these two pixels may be automatically assigned to the color of the surface area.

FIG. 3B illustrates an example process 300B of determining a bounding box. As an example and not by way of limitation, the rendering engine may determine the (u, v) coordinates of the projected pixel position 322 within the texture coordinate system. Then, the system may determine the four corner positions 341, 342, 343, and 344 of the pixel in the texture coordinate system based on the pixel position 332 (which is the pixel center) and the pixel length, pixel width parameters. The rendering engine may first compute the (u, v) coordinates and provide them as arguments when sampling the pixel at the screen space location of (x, y). Using the (u, v) coordinates and their derivatives

$$( \frac{du}{dx} , \frac{du}{dy} , \frac{dv}{dx} , \frac{dv}{dy} ) ,$$

the rendering engine may determine a bounding box as shown in FIG. 3B. The four corners (c₁, c₂, c₃, c₄) of the pixel may be computed using the following Equations (1)-(4):

$${c}_{1} = u + \frac{1}{2} \cdot ( \frac{du}{dx} + \frac{du}{dy} ) , v + \frac{1}{2} \cdot ( \frac{dv}{dx} + \frac{dv}{dy} ) \qquad ( 1 )$$

$${c}_{2} = u + \frac{1}{2} \cdot ( \frac{du}{dx} - \frac{du}{dy} ) , v + \frac{1}{2} \cdot ( \frac{dv}{dx} - \frac{dv}{dy} ) \qquad ( 2 )$$

$${c}_{3} = u - \frac{1}{2} \cdot ( \frac{du}{dx} + \frac{du}{dy} ) , v - \frac{1}{2} \cdot ( \frac{dv}{dx} + \frac{dv}{dy} ) \qquad ( 3 )$$

$${c}_{4} = u - \frac{1}{2} \cdot ( \frac{du}{dx} - \frac{du}{dy} ) , v - \frac{1}{2} \cdot ( \frac{dv}{dx} - \frac{dv}{dy} ) \qquad ( 4 )$$

The four sides of the bounding box 310 may be computed using the following Equations (5)-(8):

$${u}_{bbox \_ min} = min ( u + \frac{1}{2} \cdot ( \frac{du}{dx} + \frac{du}{dy} ) , u + \frac{1}{2} \cdot ( \frac{du}{dx} - \frac{du}{dy} ) , u - \frac{1}{2} \cdot ( \frac{du}{dx} + \frac{du}{dy} ) , u - \frac{1}{2} \cdot ( \frac{du}{dx} - \frac{du}{dy} ) ) \qquad ( 5 )$$

$${u}_{bbox \_ max} = max ( u + \frac{1}{2} \cdot ( \frac{du}{dx} + \frac{du}{dy} ) , u + \frac{1}{2} \cdot ( \frac{du}{dx} - \frac{du}{dy} ) , u - \frac{1}{2} \cdot ( \frac{du}{dx} + \frac{du}{dy} ) , u - \frac{1}{2} \cdot ( \frac{du}{dx} - \frac{du}{dy} ) ) \qquad ( 6 )$$

$${u}_{bbox \_ min} = min ( v + \frac{1}{2} \cdot ( \frac{dv}{dx} + \frac{dv}{dy} ) , v + \frac{1}{2} \cdot ( \frac{dv}{dx} - \frac{dv}{dy} ) , v - \frac{1}{2} \cdot ( \frac{dv}{dx} + \frac{dv}{dy} ) , v - \frac{1}{2} \cdot ( \frac{dv}{dx} - \frac{dv}{dy} ) ) \qquad ( 7 )$$

$${u}_{bbox \_ max} = max ( v + \frac{1}{2} \cdot ( \frac{dv}{dx} + \frac{dv}{dy} ) , v + \frac{1}{2} \cdot ( \frac{dv}{dx} - \frac{dv}{dy} ) , v - \frac{1}{2} \cdot ( \frac{dv}{dx} + \frac{dv}{dy} ) , v - \frac{1}{2} \cdot ( \frac{dv}{dx} - \frac{dv}{dy} ) ) \qquad ( 8 )$$

In particular embodiments, the bounding box 310 may correspond to a geometry shape (e.g., a rectangular or square) that contains the pixel area and is aligned to the two dimensions of the texture coordinate system. The edges 351 and 353 of the bounding box 310 may be parallel to the u dimension of the texture coordinate system. The edges 352 and 354 may be parallel to the v dimension of the texture coordinate system. In particular embodiments, the four edges (351, 352, 353, 354) of the bounding box 310 may pass through the four corners (341, 342, 343, 344). The bounding box 310 may correspond to a smallest geometric shape (e.g., a rectangular or square) that contain the pixel area enclosed by the four corners (341, 342, 343, 344) of the pixel.

In particular embodiments, because the bounding box 310 is aligned with the two dimensions (u, v) of the texture coordinate system, the bounding box 310 may be compared to the vector shapes very efficiently because these vector shapes are also in the texture coordinate system. All shapes that are outside this bounding box may have no coverage on the sampling pixel and can be safely discarded. The following Equations (9)-(12) may be used to determine the shapes that are outside the bounding box:

$${u}_{bbox \_ max} < {u}_{shape \_ min} \qquad ( 9 )$$

$${u}_{bbox \_ min} > {u}_{shape \_ max} \qquad ( 10 )$$

$${v}_{bbox \_ max} < {v}_{shape \_ min} \qquad ( 11 )$$

$${u}_{bbox \_ min} > {u}_{shape \_ max} \qquad ( 12 )$$

In other words, the vector shapes having a maximum u value (or v value) that is smaller than the minimum u value (or v value) of the bounding box 310 may have zero chance to overlap with the bounding box 310. Similarly, the vector shapes that have a minimum u value (or v value) that is greater than the maximum u value (or v value) of the bounding box may have zero chance to overlap with the bounding box 310. These vector shapes may be quickly filtered out and can be safely discarded and excluded from subsequent transformations and computation to save computational resources.

FIG. 3C illustrates example vector shapes (e.g., 361A, 362A, 363A, 364A, 365A) that intersect with the bounding box 310 of the pixel. It is notable that the vector shapes that intersect with the bounding box 310 of the pixel do not necessary intersect with the pixel area as enclosed by the four corners of the pixel. For example, the vector shapes 361A, 362A, 363A, and 364A each intersects with the pixel bounding box 310, but they do not intersect with the pixel area as enclosed by the four corners of the pixel. Thus, these four shapes may be false positive results of the fast filtering using the bounding box. Although the rendering engine may only use the vector shapes that intersect with the pixel area (rather than merely the bounding box) to determine the color values for the pixel, the rendering engine may transform all remaining vector shapes from the fast filtering step using the bounding box to the display coordinate system as represented by the (x, y) coordinate system in FIG. 3C. Then, the rendering engine may determine and select the vector shapes (e.g., 365A) that intersects with the pixel area enclosed by the four corner of the pixel, and use the selected vector shapes to compute the coverage proportion. In this example as shown in FIG. 3C, the rendering engine may select the vector shape 365A based on a determination that the vector shape 365A intersects with the pixel area of the pixel. The rendering engine may discard the vector shapes 361A, 362A, 363A, and 364A based on a determination that these vector shapes only intersect with the bounding box 310 of the pixel but do not intersect with the pixel area of the pixel.

To analytically anti-alias a pixel, the faction of pixel area that is covered by each intersecting vector shape in the vector graphics may need to be computed by the rendering engine. To do this, the rendering engine may first transform the vector shapes into the same coordinate space as that of the pixel (i.e., the display coordinate system or space). The rendering engine may perform three transformations for each vector shape. The three transformation matrices may be unified for simplicity and to reduced the number of redundant computation as shown in Equation (13). Such transformation may be performed for each vector shape that survived the bounding box filtering process.

$$TMatrix = [ \begin{matrix}1 & 0 & 0.5 \\ 0 & 1 & 0.5 \\ 0 & 0 & 1\end{matrix} ] \times [ \begin{matrix}\frac{A}{D} & - \frac{B}{A \cdot D} & 0 \\ 0 & \frac{1}{A} & 0 \\ 0 & 0 & 1\end{matrix} ] \times [ \begin{matrix}1 & 0 & - u \\ 0 & 1 & - v \\ 0 & 0 & 1\end{matrix} ] \qquad ( 13 )$$

The shape transformations may allow the shape geometry and the pixels to be located in the same coordinate space. A vector graphics texture may support different types of primitives (or shapes) including trapezoids and curves. The rendering engine may evaluate each intersecting shape to determine the coverage proportion on the pixel area. To calculate the area of fraction of pixel covered by a shape, the rendering engine may calculate the area of two vertical edges of the trapezoid and subtract them. The area of a trapezoid edge may be defined as the intersection area of the left project of a trapezoid's edge with the left edge of the unit square pixel. The coverage area calculation of trapezoid pixel intersection may be broken into three steps. First, the rendering engine may clip and cull the trapezoid edges. The rendering engine may cull the edges that have no impact on pixel coverage area and clip the edges to only keep the portion of the edge that impacts the pixel coverage. Second, the rendering engine may calculate the intersection coordinates. This step may calculate the coordinates where each trapezoid edge intersects with the unit square pixel. Third, the rendering engine may calculate edge area and trapezoid area. This step may calculate the areas of the quads formed by the left edge of the pixel (x=0) with the left projection of left and right edge of the trapezoid, respectively. Then, the rendering engine may subtract the two areas to get the trapezoid intersection area with the unit square pixel. The calculations for the faction of the pixel area covered by a curve may use the same or similar principle as described here.

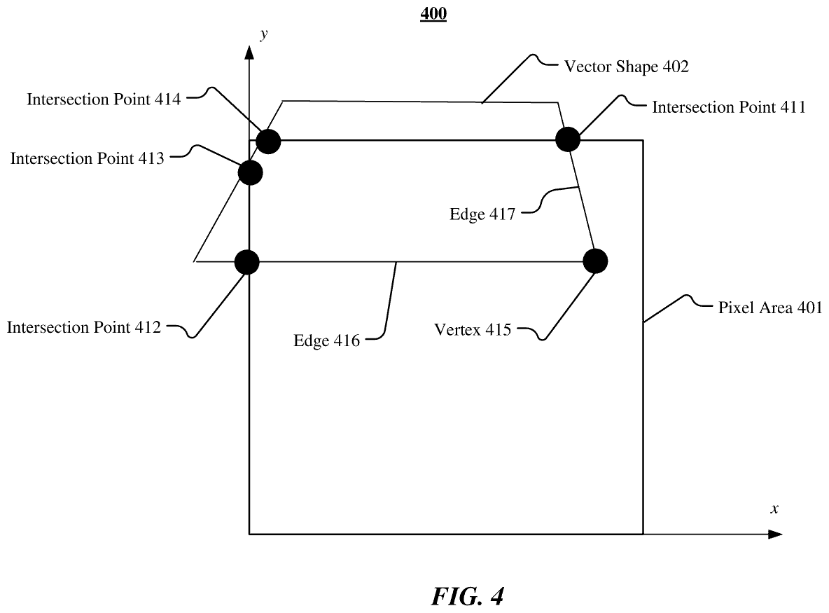

FIG. 4 illustrates an example process 400 of computing the coverage proportion of the pixel area by an intersecting vector shape. As an example and not by way of limitation, the vector shape 402 may intersect with the pixel area 401. The rendering engine may determine the intersecting points (411, 412, 413, 414) of the vector shape 402 with the edges of the pixel area 401. The rendering engine may discard the areas within the vector shape 402 but outside the pixel area 401. For each edge of the vector shape 402, the rendering engine may evaluate the edge and classify the edges into inside-pixel edges and outside-pixel edges. Vertices of all inside-pixels edges may be accumulated to create the intersecting polygon. For example, the rendering engine may keep the edges 416 and 417 and the vertex 415 that fall within the pixel area 402, which together with the intersection points 411-414, form an intersecting polygon. The rendering engine may compute the area of this intersecting polygon and divide the area value of the intersecting polygon by the pixel area 401 to determine the coverage fraction. The vector shape 502 may be associated with a color. The rendering engine may determine the color value for the pixel based on the coverage fraction of the vector shape 502 and the associated color value. It is notable that there may be multiple vector shapes the intersect with the pixel area 401. The rendering engine may determine, for each intersecting vector shape, an intersecting polygon and calculate the coverage fraction or proportion for that intersection polygon. Each intersecting vector shape may be associated with a color value. The ultimate color value for the pixel may correspond to a combination result of all the associated color values as weighted by respective coverage fraction.

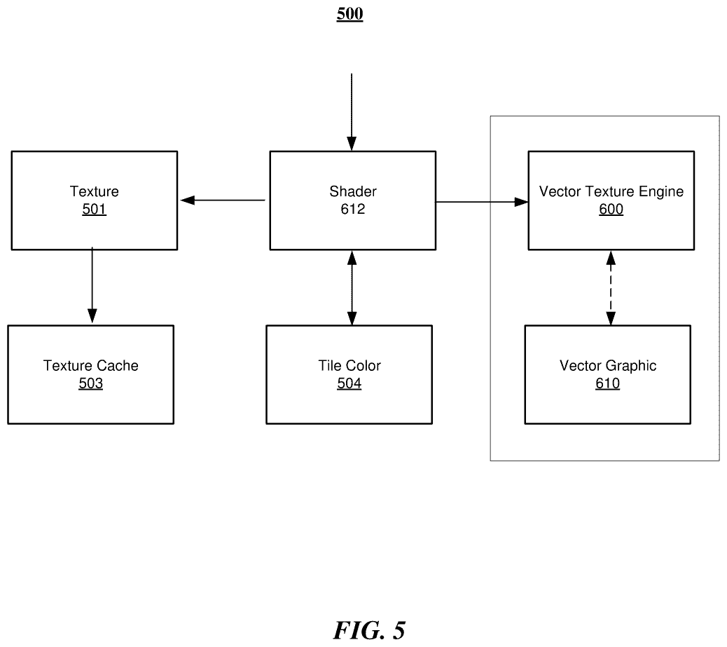

FIG. 5 illustrates an example hardware implementation 500 using the vector texture engine 600. The vector textures may be stored in the texture module 501 and may be cached by the texture cache 503. The shader 612 may access the tile color from the tile color module 504. The vector texture engine (VTE) 600 may be responsible for fetching vector graphics textures and interpolating them per pixel using analytic anti-alias algorithm for vector graphic rendering. The VTE 600 may be invoked by the shader 502 with the sample vector texture instructions. The VTE 600 may receive the descriptor for the vector texture, (u, v) coordinates for a quad of pixels and (u, v) derivatives (du/dx, du/dy, dv/dx, and dv/dy) for the same quad of pixels. The VTE 600 may access vector graphics from the vector graphic module 610 and output a color value (4 in total) for each pixel in the quad per sample vector texture instructions.

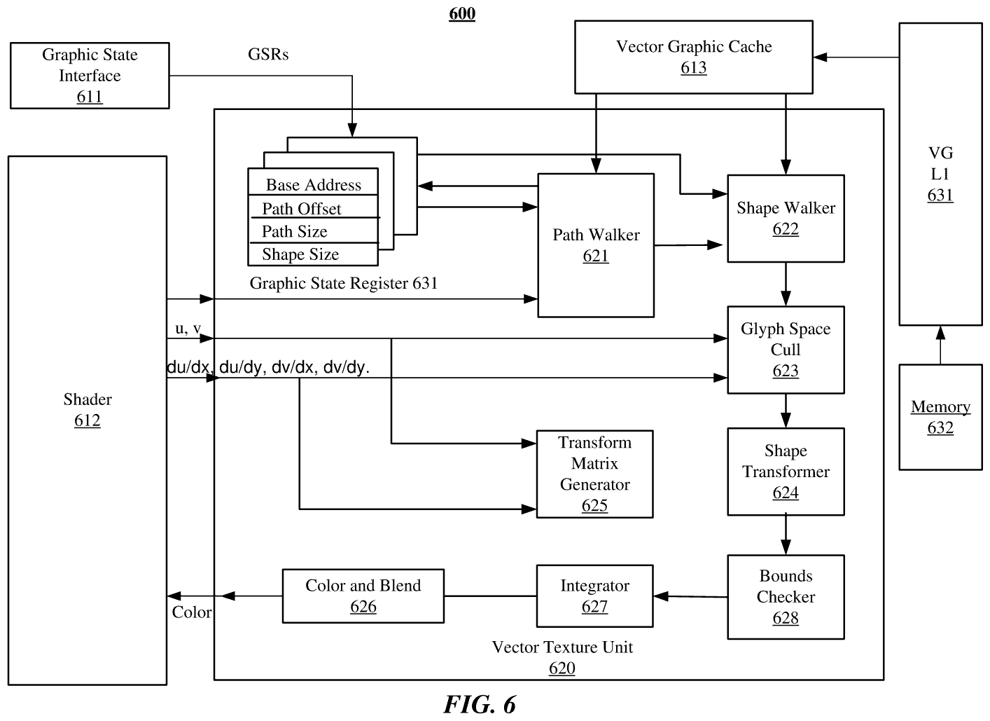

FIG. 6 illustrates example inner blocks of the vector texture engine (VTE) 600. As an example and not by way of limitation, the VTE 600 may include a path walker (PW) 621, the shape walker (SW) 622, the vector graphic cache (VG$) 613, the transform matrix generator (TMG) 625, the shape transform (ST) 624, the bounds check (BC) 628, the integrator 627, the color and blend (C&B) 626, etc. For the order of the operations, first, the graphic state interface 611 may be used to update the graphic state register (GSRs) 631. Second, the shader 612 may issue a vector texture sample command for a quad of pixels by communicating the descriptor, the (u, v) coordinates of each pixel in the quad and derivatives (du/dx, du/dy, dv/dx, and dv/dy) for the quad. Third, the PW 621 and TMG 625 may simultaneously begin their operations. PW 621 may use the descriptor to index into the right set of GSRs and use base address, path offset, and path size to generate path addresses and use it to fetch shape base address for each path from vector graphic cache 613. The TMG 625 may use the (u, v) coordinate and derivatives (du/dx, du/dy, dv/dx, and dv/dy) to generate a transform matrix for each of the four sample in the quad. Fourth, for each path, the SW 622 may use the shape base address received from the PW 621 and the shape size GSR to fetch shape vertices from vector graphic cache 613. Fifth, the ST 624 may use shape vertices received from the SW 622 and transformation matrices from the TMG 625 to generate four transforms (one per sample) per shape vertex (each valid shape is represented with 3 vertices). Sixth, the BC 628 may receive transforms for each shape and perform a bounding box test. Seventh, the integrator 627 may compute the coverage area fraction per pixel for all shapes that pass the bounding box test in the BC 628. Eighth, the color and blend block 626 may blend color values of all shapes for each pixel according to the path properties and coverage area fraction computed by the integrator block. Ninth, the four color values (one per pixel in the quad) may be communicated to the shader 612 for subsequent use.

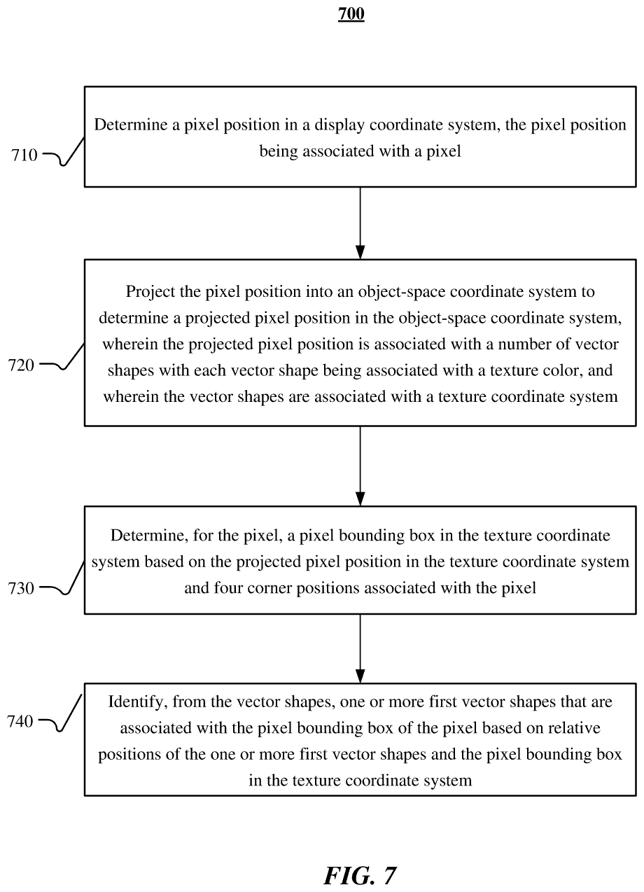

FIG. 7 illustrates an example method 700 of using a bounding box to identify vector shapes to be used to determine a color value for the pixel. The method begins at step 710, where a computing system may determine a pixel position in a display coordinate system, the pixel position being associated with a pixel. At step 720, the system may project the pixel position into an object space (e.g., three-dimensional space) coordinate system to determine a projected pixel position in the object space coordinate system. The projected pixel position may be associated with a number of vector shapes with each vector shape being associated with a texture color. The vector shapes may be associated with a texture coordinate system. At step 730, the system may determine, for the pixel, a bounding box in the texture coordinate system based on the projected pixel position in the texture coordinate system and a number of corner positions (e.g., four corner positions for rectangular pixel or square pixel) associated with the pixel. At step 740, the system may identify, from the vector shapes associated with the projected pixel position, one or more first vector shapes that are associated with the bounding box of the pixel based on relative positions of the one or more first vector shapes and the bounding box in the texture coordinate system. In particular embodiments, the object-space coordinate system may be a three-dimensional coordinate system or a two-dimensional coordinate system associated with the objects of the scene.

In particular embodiments, the one or more first vector shapes may be identified based on a determination that the one or more first vector shapes each intersects with the bounding box in the texture coordinate system. In particular embodiments, the system may discard one or more second vector shapes based on a determination that the one or more second vector shapes fail to intersect with the bounding box of the pixel. In particular embodiments, the system may transform the one or more first vector shapes from the texture coordinate system to the display coordinate system. The system may identify an intersecting first vector shape from the one or more first vector shapes based on a determination that the intersecting first vector shape intersects with a pixel area enclosed by the corner positions (e.g., 4) of the pixel in the display coordinate system.

In particular embodiments, the system may determine an overlap proportion of the pixel area for the intersecting first vector shape. The overlap proportion may correspond to an overlapping area of the intersecting first vector shape and the pixel area of the pixel in the display coordinate system. The system may determine a color value for the pixel based at least on the overlap proportion of the intersecting first vector shape and a texture color associated with the intersecting first vector shape. In particular embodiments, the pixel position may correspond to a center point of the pixel in the display coordinate system. The pixel position may be projected to the object space coordinate by casting a ray from a viewpoint of the user passing through the pixel position to a surface associated with a mesh grid model of an object in the object space coordinate system. In particular embodiments, the projected pixel position may correspond to an intersecting point of the casted ray and the surface of the mesh grid of the object. The surface may be mapped to the texture coordinate system associated with the plurality of vector shapes each being associated with a texture color. In particular embodiments, the corner positions of the pixel may be determined based on (1) the coordinates of the intersecting point of the casted ray and the surface and (2) a length and a width of the pixel.

In particular embodiments, the bounding box may contain the pixel area enclosed by the corners of the pixel in the texture coordinate system. A first edge and a second edge of the bounding box of the pixel may be parallel to a first dimension of the texture coordinate system. A third edge and a fourth edge of the bounding box may be parallel to a second dimension of the texture coordinate system. In particular embodiments, the first, second, third, and fourth edges of the bounding box of the pixel may each pass through a corner of the pixel in the texture coordinate system. In particular embodiments, the bounding box of the pixel may correspond to the smallest rectangular that contains a pixel area of the pixel in the texture coordinate system and may be aligned with the first and second dimensions of the texture coordinate system. In particular embodiments, the computing system may include a graphics processing unit (GPU) which has an integrated vector graphic engine dedicated for handling vector graphics texture sampling.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method of using a bounding box to identify vector shapes to be used to determine a color value for the pixel including the particular steps of the method of FIG. 7, this disclosure contemplates any suitable method of using a bounding box to identify vector shapes to be used to determine a color value for the pixel including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

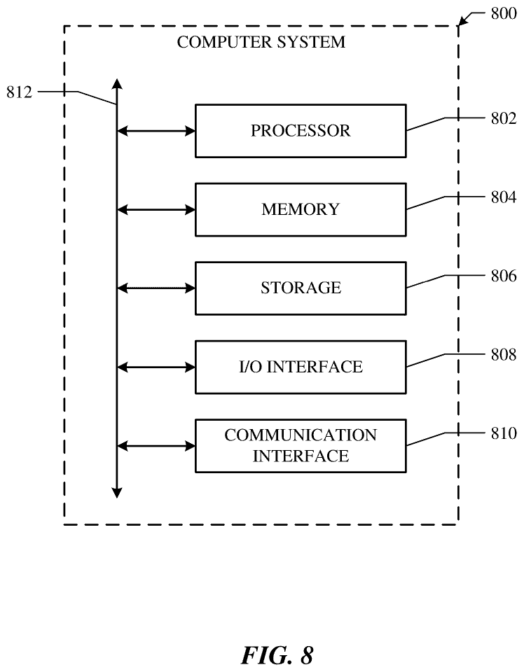

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
determining a pixel position in a display coordinate system, the pixel position being associated with a pixel;
projecting the pixel position into an object-space coordinate system to determine a projected pixel position in the object-space coordinate system, wherein the projected pixel position is associated with a plurality of vector shapes with each vector shape being associated with a texture color, and wherein the plurality of vector shapes are associated with a texture coordinate system;
determining, for the pixel, a bounding box in the texture coordinate system based on the projected pixel position in the texture coordinate system and a plurality of corner positions associated with the pixel; and
identifying, from the plurality of vector shapes, one or more first vector shapes that are associated with the bounding box of the pixel based on relative positions of the one or more first vector shapes and the bounding box in the texture coordinate system.

2. The method of claim 1, wherein the one or more first vector shapes are identified based on a determination that the one or more first vector shapes each intersects with the bounding box in the texture coordinate system.

3. The method of claim 2, further comprising:
discarding one or more second vector shapes based on a determination that the one or more second vector shapes fail to intersect with the bounding box of the pixel.

4. The method of claim 3, further comprising:
transforming the one or more first vector shapes from the texture coordinate system to the display coordinate system; and
identifying an intersecting first vector shape from the one or more first vector shapes based on a determination that the intersecting first vector shape intersects with a pixel area enclosed by the a plurality of corner positions of the pixel in the display coordinate system.

5. The method of claim 4, further comprising:
determining an overlap proportion of the pixel area for the intersecting first vector shape, wherein the overlap proportion corresponds to an overlapping area of the intersecting first vector shape and the pixel area of the pixel in the display coordinate system; and
determining a color value for the pixel based at least on the overlap proportion of the intersecting first vector shape and a texture color associated with the intersecting first vector shape.

6. The method of claim 1, wherein the pixel position corresponds to a center point of the pixel in the display coordinate system, and wherein the pixel position is projected to the object-space coordinate by casting a ray from a viewpoint of a user passing through the pixel position to a surface associated with a mesh grid model of an object in the object-space coordinate system.

7. The method of claim 6, wherein the projected pixel position corresponds to an intersecting point of a casted ray and the surface of the mesh grid of the object, and wherein the surface is mapped to the texture coordinate system associated with the plurality of vector shapes each being associated with a texture color.

8. The method of claim 7, wherein the plurality of corner positions of the pixel is determined based on (1) the coordinates of the intersecting point of the casted ray and the surface and (2) a length and a width of the pixel.

9. The method claim 1, wherein the bounding box contains a pixel area enclosed by the plurality of corner positions of the pixel in the texture coordinate system, wherein a first edge and a second edge of the bounding box of the pixel are parallel to a first dimension of the texture coordinate system, and wherein a third edge and a fourth edge of the bounding box are parallel to a second dimension of the texture coordinate system.

10. The method of claim 9, wherein the first, second, third, and fourth edges of the bounding box of the pixel each passes through a corner position of the plurality of corner positions of the pixel in the texture coordinate system.

11. The method of claim 9, wherein the bounding box of the pixel corresponds to a smallest rectangular that contains a pixel area of the pixel in the texture coordinate system and is aligned with the first and second dimensions of the texture coordinate system.

12. The method of claim 1, wherein the computing system comprises a graphics processing unit (GPU) comprising an integrated vector graphic engine dedicated for handling vector graphics texture sampling.

13. One or more computer-readable non-transitory storage media embodying software that is operable when executed to:
determine a pixel position in a display coordinate system, the pixel position being associated with a pixel;
project the pixel position into an object-space coordinate system to determine a projected pixel position in the object-space coordinate system, wherein the projected pixel position is associated with a plurality of vector shapes with each vector shape being associated with a texture color, and wherein the plurality of vector shapes are associated with a texture coordinate system;
determine, for the pixel, a bounding box in the texture coordinate system based on the projected pixel position in the texture coordinate system and a plurality of corner positions associated with the pixel; and
identify, from the plurality of vector shapes, one or more first vector shapes that are associated with the bounding box of the pixel based on relative positions of the one or more first vector shapes and the bounding box in the texture coordinate system.

14. The media of claim 12, wherein the one or more first vector shapes are identified based on a determination that the one or more first vector shapes each intersects with the bounding box in the texture coordinate system.

15. The media of claim 12, further embodying software that is operable when executed to:
discard one or more second vector shapes based on a determination that the one or more second vector shapes fail to intersect with the bounding box of the pixel.

16. The media of claim 14, further embodying software that is operable when executed to:
transform the one or more first vector shapes from the texture coordinate system to the display coordinate system; and
identify an intersecting first vector shape from the one or more first vector shapes based on a determination that the intersecting first vector shape intersects with a pixel area enclosed by the plurality of corner positions of the pixel in the display coordinate system;
determine an overlap proportion of the pixel area for the intersecting first vector shape, wherein the overlap proportion corresponds to an overlapping area of the intersecting first vector shape and the pixel area of the pixel in the display coordinate system; and
determine a color value for the pixel based at least on the overlap proportion of the intersecting first vector shape and a texture color associated with the intersecting first vector shape.

17. A system comprising:
one or more non-transitory computer-readable storage media embodying instructions; and
one or more processors coupled to the storage media and operable to execute the instructions to:
determine a pixel position in a display coordinate system, the pixel position being associated with a pixel;
project the pixel position into an object-space coordinate system to determine a projected pixel position in the object-space coordinate system, wherein the projected pixel position is associated with a plurality of vector shapes with each vector shape being associated with a texture color, and wherein the plurality of vector shapes are associated with a texture coordinate system;
determine, for the pixel, a bounding box in the texture coordinate system based on the projected pixel position in the texture coordinate system and a plurality of corner positions associated with the pixel; and
identify, from the plurality of vector shapes, one or more first vector shapes that are associated with the bounding box of the pixel based on relative positions of the one or more first vector shapes and the bounding box in the texture coordinate system.

18. The system of claim 17, wherein the one or more first vector shapes are identified based on a determination that the one or more first vector shapes each intersects with the bounding box in the texture coordinate system.

19. The system of claim 17, further being configured to:
discard one or more second vector shapes based on a determination that the one or more second vector shapes fail to intersect with the bounding box of the pixel.

20. The system of claim 18, further being configured to:
transform the one or more first vector shapes from the texture coordinate system to the display coordinate system;
identify an intersecting first vector shape from the one or more first vector shapes based on a determination that the intersecting first vector shape intersects with a pixel area enclosed by the plurality of corner positions of the pixel in the display coordinate system;
determine an overlap proportion of the pixel area for the intersecting first vector shape, wherein the overlap proportion corresponds to an overlapping area of the intersecting first vector shape and the pixel area of the pixel in the display coordinate system; and
determine a color value for the pixel based at least on the overlap proportion of the intersecting first vector shape and a texture color associated with the intersecting first vector shape.
